(19) United States
(12) Patent Application Publication
(10) Pub. No.: US 2002/0194166 A1
(43) Pub. Date: Dec. 19, 2002

(54) Mechanism to sift through search results using keywords from the results

(76) Inventor: Abraham Michael Fowler, Dallas, TX (US)

Correspondence Address: ABRAHAM MICHAEL FOWLER, 5757 E. UNIVERSITY BLVD #27J, DALLAS, TX, 75206, US

(21) Appl. No.: 10/074,654

(22) Filed: Feb. 14, 2002

Related U.S. Application Data
(60) Provisional application No. 60/287,369, filed on May 1, 2001.

(51) Int. Cl. G06F 7/00

(52) U.S. Cl. 707/3

(57) ABSTRACT

A mechanism or computer system which aids the user in sifting through a list of search results from a search query on a collection of documents. It does so by 1) processing the list of search results, 2) extracting a list of keywords from the results, 3) presenting the keywords to the user, 4) allowing the user to select keywords and apply sifting operations to those keywords, and 5) producing a sifted list from the original list of search results using the user's selections. The sifted list may exclude some of the original search results and may reorder the remaining results to match the user's selections. Finally, this invention may provide a function to combine the user-selected keywords and sifting operations with the original query to produce a more restricted or refined query to resubmit to the search engine.

### CROSS-REFERENCE TO RELATED APPLICATIONS

I filed a provisional patent application for the present invention on May 1, 2001. The number for that provisional application is 60/287,369. It was filed under the same inventor name and invention title as the present invention.

Cross-reference to Related Applications

Statement Regarding Federally Sponsored Research or Development

Reference to a Computer Program Listing Appendix

Field of the Invention

Background of the Invention and Prior Art

Summary of the Invention

Brief Descriptions of the Several Views of the Drawing

Detailed Description of the Invention

Claims

Abstract of the Disclosure

A portion of the disclosure of this patent document contains material which is subject to copyright protection. The copyright owner has no objection to the facsimile reproduction by anyone of the patent document or the patent disclosure, as it appears in the Patent and Trademark Office patentfile or records, but otherwise reserves all copyright rights whatsoever.

### STATEMENT REGARDING FEDERALLY SPONSORED RESEARCH OR DEVELOPMENT

Not applicable.

### REFERENCE TO A COMPUTER PROGRAM LISTING APPENDIX

This specification includes a computer program listing appendix, submitted with the application in CD-R format. Two copies are submitted with this application. The contents of each CD-R are as follows:

| Filename | Size in bytes | Date |
|---|---|---|
| Readme.txt | 2,037 | 1/25/02 |
| dist/ThistleSifter.jar | 40,664 | 1/25/02 |
| docs/Application for Patent.doc | 84,480 | 1/25/02 |
| docs/drawings/Backside of drawings.vsd | 19,968 | 1/5/02 |
| docs/drawings/Figure 1.vsd | 70,656 | 1/5/02 |
| docs/drawings/Figure 2.vsd | 159,744 | 1/5/02 |
| docs/drawings/Figure 3.vsd | 133,120 | 1/5/02 |
| src/manifest.txt | 45 | 1/25/02 |
| src/com/thistlesifter/Keyword.java | 3,047 | 1/15/02 |
| src/com/thistlesifter/KeywordList.java | 9,784 | 1/15/02 |
| src/com/thistlesifter/KeywordMetrics.java | 1,523 | 1/14/02 |
| src/com/thistlesifter/KeywordSifter.java | 4,485 | 1/14/02 |
| src/com/thistlesifter/Result.java | 4,709 | 1/15/02 |
| src/com/thistlesifter/ResultList.java | 3,800 | 1/15/02 |
| src/com/thistlesifter/Search.java | 19,758 | 1/15/02 |
| src/com/thistlesifter/Sifter.java | 871 | 1/14/02 |
| src/com/thistlesifter/SiftOperation.java | 3,406 | 1/14/02 |
| src/com/thistlesifter/SimpleSifter.java | 1,076 | 1/14/02 |
| src/com/thistlesifter/ThistleSifter.java | 20,657 | 1/25/02 |
| src/com/thistlesifter/util/TagReader.java | 6,271 | 1/14/02 |

### FIELD OF THE INVENTION

This invention is related, in general, to the searching of collections of documents of any kind. More specifically, it relates to a method for the user to sift through the results of a search on a collection of documents without viewing each one, using keywords extracted from or otherwise related to the documents.

### BACKGROUND OF THE INVENTION AND PRIOR ART

Searching a large collection of documents for information about which we know only a small part has always been difficult. Although this invention addresses the searching of any kind of collection of documents, the best place to illustrate its necessity is the World Wide Web. Search engines help us find pages, but all too often they deluge us with far too many results. For example, let us say a novice puzzle enthusiast wants to try his hand at cracking some good old-fashioned ciphers. To start finding basic information, he goes to Altavista¹ and searches on the keyword “codes”. Instead of getting pages on codes and ciphers, which is what he wants, he gets “about 2,459,295” results on topics such as law, genetics, programming, inventory control, telephone area codes, Bible codes, video game cheats . . . and the list goes on. Sifting manually through all these results to find exactly what he wants would be quite a daunting task for our puzzle enthusiast. ¹Altavista—http://www.altavista.com/

Part of this general problem is that our searches are rarely specific enough, usually because we do not know the proper terminology for our topic that we could use to narrow the search down without inadvertently excluding some relevant results. Human language adds to the problem because it is often ambiguous—for any given search keyword, there can be a whole spectrum of meanings. Only an expert in the desired topic might know the appropriate keywords needed to narrow down the search, and even an expert may have trouble finding the results he wants among all the irrelevant results. Let us return to our example. If our puzzle enthusiast had known more about his topic, he might have searched instead on the keywords “cipher” or “cryptography”. The keyword “cipher” would have narrowed down the results to 17,364 pages (at Altavista); combining it with the original keyword “codes” would narrow it down even further to 3,488 pages. In the enthusiast's case, choosing the correct keywords to narrow down the search required a greater depth of knowledge about the topic than he already had. The irony is that if he had deeper knowledge on the topic, he might not be searching the Web in the first place.

Prior inventions have attempted to aid the user by grouping the results of a broad initial search into subcategories. U.S. Pat. No. 6,167,397, “Method of clustering electronic documents in response to a search query,” describes one such method, which involves having the computer look through each document and algorithmically discover similarities between groups of documents in the search results. Many World Wide Web search engines now appear to have some incarnation of this method. Although this method is an improvement in that it helps the user avoid some documents that are obviously unrelated, it suffers from the same basic problem of the ambiguity of human language and the mere fact that no algorithm really understands the meaning of the document it is processing. As a result, these machine-generated categories often appear artificial and at times even misleading.

U.S. Pat. No. 5,924,090, “Method and apparatus for searching a database of records,” describes an attempt to improve further on this by using human-generated categories that have been established in a database beforehand. It attempts to fit each of these documents into one of these human-generated categories, again by a sophisticated algorithm on the document itself. This approach can be seen implemented at Northern Light's search website.² The approach is a little better than having machine-generated categories, but still falls short in that it is limited to only the pre-established categories and the knowledge of those who created them. The World Wide Web is far too vast for any human effort to fully categorize, and new categories are popping up all the time. Moreover, this approach again suffers from the same problem of the ambiguity of human speech and sometimes places documents in the wrong categories. ²Northern Light—http://www.northernlight.com/

Another invention, U.S. Pat. No. 6,012,053, “Computer system with user-controlled relevance ranking of search results,” attempts to help users bring the documents they seek to the top of the list of search results, by giving them a number of “relevancy factors” which they can control to give each individual document a “relevancy score” or ranking within the list. These relevancy factors could be things such as size of the file, date of creation, location of search terms, proximity of search terms to each other, and so on. However, by focusing only on the search terms in the query, these relevancy factors seem not to take the documents' other contents into consideration, which could be the best indicator of relevancy to the user.

Thus, while all these inventions are an improvement upon the basic search, there is still plenty of room for alternative and possibly better solutions. At present, no known mechanism allows the user to sift the results of a search based on all the keywords extracted from the results themselves, including keywords not found in the original search query. This invention pertains to such a sifting mechanism, one that allows user-controlled reordering and excluding of search results, based on keywords found in the results themselves.

### BRIEF SUMMARY OF THE INVENTION

The present invention attempts to give the user a better way to sift through the large volume of search results returned by a broad or general search query. In simplified steps, it does so by: 1) conducting a search using an internal or external search engine back-end, or otherwise receiving search results from some search query; 2) extracting keywords from each search result, for example by reading predefined keywords associated with each result by its author; 3) putting these keywords in a separate list and presenting it to the user alongside the list of search results themselves; 4) allowing the user to choose a sifting operation to apply to each keyword, for example to “include” results that match a particular keyword or to “exclude” results that match an undesirable keyword; 5) sifting and reordering the list of search results according to the user's choice of keywords and sifting operations; and 6) optionally resubmitting a more targeted, more refined version of the original search query by adding to the original query the user's choice of keywords to include or exclude.

Some of the steps briefly outlined above can be conducted in several different ways. For example, any search engine that produces adequate results, or even multiple search engines, may be used as the back end. Similarly, any algorithm that extracts useful keywords from the result documents can be used in the second step. In step three, formulating the list of keywords or search results, one particular implementation could perform simple or advanced statistical analysis to determine the optimal presentation order. Another implementation might contain algorithms that, before presenting keywords to the user, could remove keywords deemed insignificant or even perform grammatical analysis to group keywords which are different forms of the same word. The sifting operations presented to the user for keywords could encompass several different levels of “inclusion” or “exclusion,” such as 1) “require” this keyword (Boolean AND), 2) “include” documents containing this keyword (Boolean OR), and 3) “exclude” all documents containing this keyword (Boolean AND NOT). Other sifting operations, such as aggregating results or keywords, could also be applied.

Regardless of all these and other potential enhancements, the overall mechanism for sifting results based on keywords and sifting operations remains the same. It is the overall sifting mechanism that constitutes the present invention.

### BRIEF DESCRIPTIONS OF THE SEVERAL VIEWS OF THE DRAWING

FIG. 1 is a diagram of the information flow between entities at four stages (a, b, c, d) of the process; in this diagram, each shape represents an entity in the system, arrows represent the flow of information, and the text next to the arrows describes the information flow.

FIG. 2 is a high-level flowchart giving a general view of the steps in the process. Each step in the flowchart is labeled with a letter.

FIG. 3 illustrates a prototypical user interface for the present invention; where (a) shows the overall interface including the list of keywords and search results, and (b) is a cutaway showing the sifting operations available for each keyword.

### DETAILED DESCRIPTION OF THE INVENTION

Before delving into the full description of the invention, it will be helpful to define certain terms precisely, as follows:

Search Engine: any software module or program which can search a collection of documents using a query and return a list of matching results.

Search Result: a “hit” or single match for a particular query from a collection of documents.

Keyword: any word or phrase which could be used in a search for a document, and which pertains closely to the subject of the document. Ideally associated directly with the document itself by the author or categorizer of the document, though it could come from an algorithm analyzing the document itself.

Sifting: The process of going through the search results, excluding unwanted results based on keywords and user-selected sifting operations on those keywords, and arranging the remaining search results in order of number of included keywords or some other ranking algorithm.

Sifting Operation: Any operation associated with a keyword, which causes a document to be included in, excluded from, or ranked within the list of search results, based on the keyword and its presence or absence in that document.

Having defined the above terms, let us move on to the full description of the invention. The description of the functioning of the present invention is split into four main phases, for convenience and clarity. (The division into four phases here is merely didactical; it is not meant to be understood as intrinsic or necessary to the design or function of the invention.)

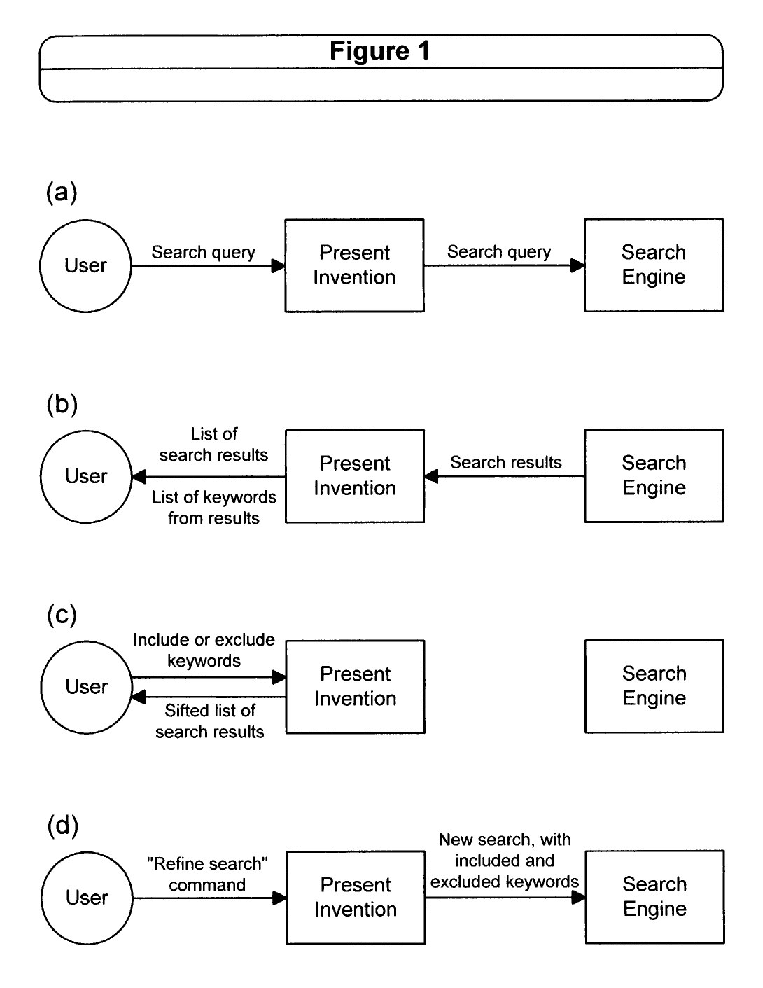

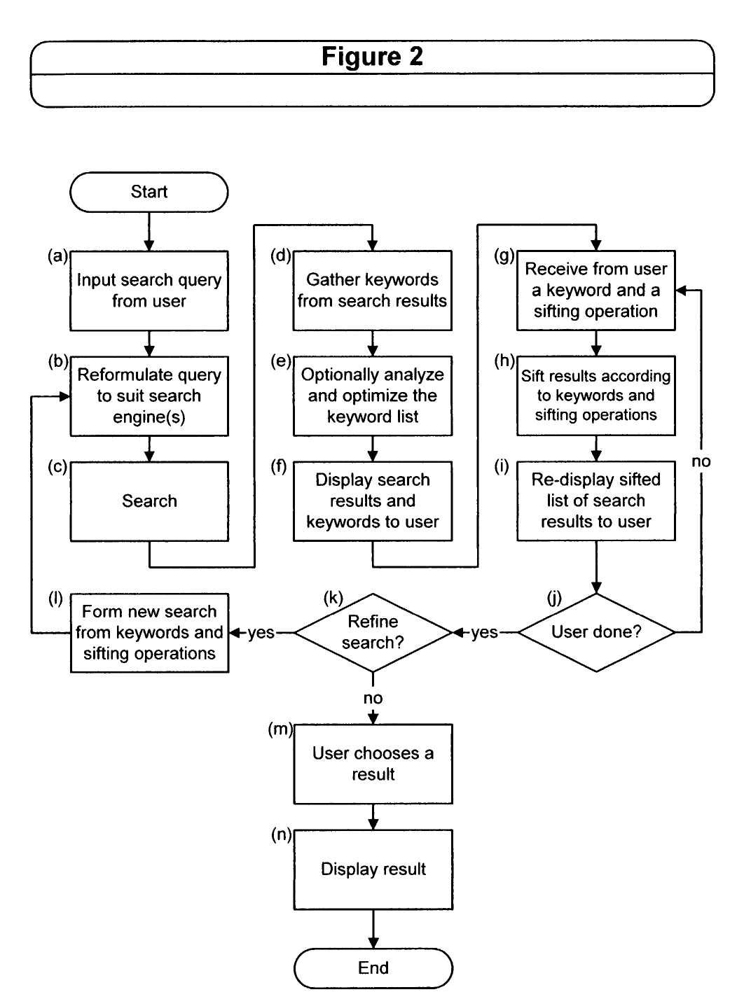

In the first phase, the present invention begins with a search query, input by the user or otherwise passed to the invention. The broader and more general the query, the more useful the present invention will ultimately be. At this point, the invention could potentially reformulate the search query to suit a particular search engine, especially if the present invention was programmed to use more than one search engine, or perform some other optimization on the query. The search query is then passed to the search engine back-end, which does its own internal processing and comes up with a list of search results. The flow of information in phase one is illustrated in FIG. 1, (a), and the general programmatic steps taken by the present invention are laid forth in FIG. 2, (a) (b) and (c).

In the second phase, the search engine back-end has processed the search query and returned a list of search results to the present invention. The present invention then processes this list of search results to gather keywords from each result, using any of a variety of algorithms. The keywords gathered are then compiled into a single list of keywords. After processing, the present invention presents the list of keywords and the list of search results to the end user. The flow of information in phase two is illustrated in FIG. 1, (b), and the general programmatic steps taken by the present invention are laid forth in FIG. 2, (d) (e) and (f). Let us examine the flowchart steps from FIG. 2 a little more closely.

In FIG. 2, (d), the present invention uses any one of various algorithms to extract keywords from the search results. The most ideal way to get good keywords is for each document to have a list of associated keywords. Library book cataloguing systems associate keywords with each book, for example, and World Wide Web pages coded in HTML (Hyper Text Markup Language) can contain meta-tags which list the keywords for the page. In such cases, the extraction algorithm is simply to add the keywords from each document to the present invention's master list of keywords, optionally compiling other statistics, such as frequency of keyword occurrence, in the process.

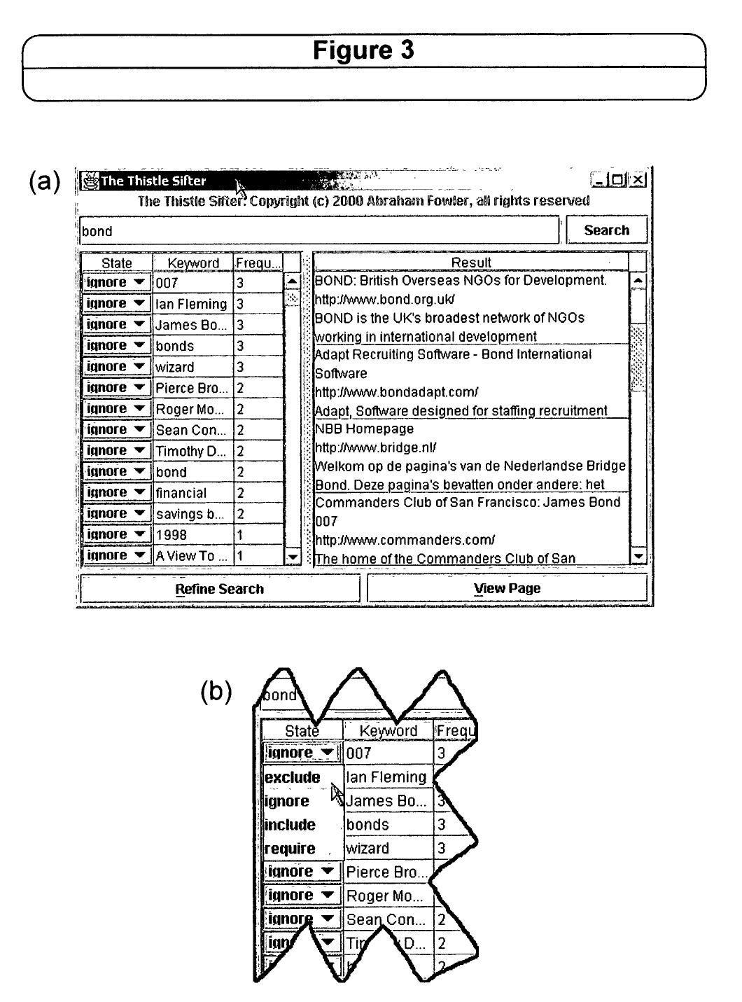

In FIG. 2, (f), the present invention presents the list of keywords and the list of search results to the user. This can be done through any suitable user interface, such as a Java form, an HTML page, a wireless phone display, a library computer terminal, and so on. FIG. 3, (a) illustrates the interface used by the prototype of the present invention to display these two lists to the user. The scope of this invention is not limited by the choice of user interface, as long as the interface can suitably present these two lists to the user, and interactively accept input from the user, as described in more detail in phase three below.

In the third phase, the user interacts with the present invention by selecting a keyword from the keyword list, and choosing from several sifting operations available for that keyword. The most basic sifting operations are “include” and “exclude.” During the sifting of documents, these keywords and sifting operations would determine a particular result's inclusion in or exclusion from the list of search results. The present invention then uses the keywords and operations selected by the user to re-sift the list of search results. The sifting process will exclude certain results based on the selected keywords and sifting operations, and may optionally reorder the remaining search results based on other keywords and sifting operations. After sifting the list of search results, the present invention then re-displays them to the user. The user can then choose to interact further with the list of keywords, or move on to view a search result or refine the search. This flow of information is illustrated in FIG. 1, (c), and the general programmatic steps taken by the present invention are laid forth in FIG. 2, (g) (h) (i) (j) and (k). Let us examine the steps from FIG. 2 a little more closely.

In FIG. 2, (g), many different user interfaces could be employed to allow the user to interact with the keyword and search result lists. For example, in FIG. 3, (b) the present invention's initial prototype displays next to each keyword a “combo box” or dropdown list containing the various sifting operations. A command-line interface, to use a very different example, could use typed text commands to select keywords to operate on in sifting the list of search results. As long as the user interface allows the user to select a keyword and its sifting operation, that user interface satisfies the requirements of the step in FIG. 2, (g). The example user interfaces given here are illustrative only, and should be understood not to limit the scope of this invention.

Also in FIG. 2, (g), the user must choose a keyword and a sifting operation to use with that keyword. The sifting operation will be used in FIG. 2, (h) as part of the sifting algorithm, so the set of operations used in (h) should be made accessible to the user in (g). Typically, the minimal set of available sifting operations are to “include” or “exclude” from the list of search results those documents containing the given keyword. However, any operation which can be used with the keyword to select, rank, or exclude a document within the sifting algorithm can be defined. For example, the present invention's initial prototype—see FIG. 3, (b)—provides four sifting operations, named “require,” “include,” “ignore,” and “exclude.” In the case of the prototype, “require” represented a Boolean AND between the selected keyword and each document's list of keywords; “include” represented a Boolean OR; “ignore” represented to ignore the keyword when re-sifting; and “exclude” represented a Boolean AND NOT between the selected keyword and each document's list of keywords.

In FIG. 2, (h), the present invention takes the list of user-selected keywords and the sifting operation associated with each one, and uses it to run a sifting algorithm on the original list of search results to produce a new, derived list of sifted search results. The effect of the sifting algorithm is to exclude unwanted results from the derived list, and optionally to reorder the ones left according to some ranking given by the sifting operations and keywords, or given by the sifting algorithm itself, or given by some combination of the two. In the prototype, those documents with the greatest number of “required” and “included” keywords were put at the top of the re-sifted list of search results.

In FIG. 2, (i), the user is presented with the sifted (derived) list of search results, in a manner similar to that described for FIG. 2, (f) before. If the user has chosen their keywords and sifting operations well, they should see a much more relevant set of documents, with the most relevant to their search right at the top of the list.

In FIG. 2, (j), the user has a choice to go back to step (g) and choose another keyword and sifting operation to further refine the sifting of the search results, or to continue on to perform other operations with the search. If the user chooses to go back, this step creates an interactive cycle by which the user can continually experiment with including, excluding, etc. different keywords until they achieve the sifted results they like. Note that with a graphical user interface, the choice in (j) should not necessarily be shown explicitly to the user as a separate step; instead, merely providing various buttons or user interface elements, each with its own function, will allow the user to navigate this step without explicitly being asked to choose.

Before continuing on to phase four, it should be clarified that each cycle through phase three may be cumulative; that is, the present invention may, if designed to do so, remember the keywords and sifting operations selected in previous cycles. A graphical user interface lends itself particularly well to displaying the sifting operation associated with each keyword at any given time, and makes this “cumulative” effect intuitive to the user—see FIG. 3, (a) and (b). With such an interface, in order to return to the original unsifted list of search results, the user must remove sifting operations from keywords (or set them to a sifting state such as “ignore,” in the prototype), or the invention could provide a “clear all sifting operations” function to do this for the user.

The user may decide to stop at phase three by selecting one of the search results to view. In such a case, the present invention displays the document or calls the appropriate functions to cause the document to be displayed. Then it may either exit, or return to the interactive cycle of phase three. FIG. 2, (m) and (n) lay forth the general programmatic steps the present invention takes for this task, although those steps do not show how a graphical user interface may exit from or return to the interactive cycle of phase three.

The user may also choose to exit phase three by issuing the “refine search” command to resubmit a new query based on their keyword selections. This command takes them directly to phase four and does not allow them to re-enter phase three until they pass through phases one and two again. A discussion of phase four follows.

The invention enters the fourth phase after the user gives the “refine search” command. In this phase, the invention combines the keywords and sifting operations they chose into the original search query, to produce a new search query more targeted to the topic they desire. For example, if the original search query was for the term “bond”, and the user selected the keyword “007” and applied the “exclude” sifting operation to it, the reformulated query string for one particular search engine could be “bond −007” (where the minus symbol tells the search engine to exclude documents with the keyword “007”). This function is especially useful with extremely large collections of documents such as the World Wide Web, since the first search query is likely to be limited by a maximum document count threshold and thus not return all possible or useful matches the first time around. When the search query is formulated, it is passed back to the step in FIG. 2, (b) from phase one, and the entire cycle of the present invention begins again. This flow of information is illustrated in FIG. 1, (d), and the general programmatic steps taken by the present invention are laid forth in FIG. 2, (k) and (l). The fourth phase, which is optional, is the final phase of the overall framework of this invention.

To give a brief example of all this at work, let us return to our puzzle enthusiast. He could start out with a broad query on the word “codes”. The search engine would probably return only the first few hundred results out of the millions it cites. The present invention would extract keywords from each search result, and present the search results alongside a separate, cumulative list of the keywords extracted from the results. Our user could then choose to include or exclude selected keywords, which would result in the search results being sifted and redisplayed based on those keywords. In this way the user could intelligently narrow his search without excluding relevant results. In our enthusiast's specific example, he might find it helpful to see that some pages share the keyword “law”, others share the keyword “gene”, still others the keyword “open source”, and so on. He could “exclude” all such keywords, and immediately see search results with those keywords disappear. He might see the keywords “cipher” or “cryptography” among the list and realize those would be good keywords to narrow his search, selecting them and using the “include” sifting operation. Immediately, search results with those keywords would come to the top of the list. Not only would he get better, more specific results, but in the process he would learn something about the proper terminology for his desired topic. Thus, one of the most helpful aspects of this invention is that it shows the user what other keywords may be available relating to their topic.

Now, following is a description of several alternatives, variations or potential improvements to parts of the present invention. Each paragraph below discusses one such improvement or variation, relating it back to the description of the overall mechanism above.

In the first phase, the search engine back-end is mentioned with little discussion of what that may actually be. In the prototype, the user entered a query directly into the present invention, which then submitted the search query to the Altavista³ World Wide Web search engine. It then processed the HTML document containing the search results, parsing it to extract document title, document location, etc. From this information it loaded the individual World Wide Web pages and extracted the keywords from their meta-tags. This, however, should not be considered to limit the methods this invention could use for receiving search results. For example, it could be augmented to use several World Wide Web search engines, reformulating the search query as necessary for each one, retrieving results from each one, and combining the results into one list for processing to extract keywords. Or, the present invention could be tied to a proprietary search engine back-end for searching a private collection of documents, such as in a library book-cataloguing system. Finally, the present invention could also work as an add-on to a search engine, in which case the search engine itself would perform the entire first phase and simply pass the results to the present invention for processing. The examples given here are illustrative only, and should be understood not to limit the scope of this invention, nor broaden it to encompass algorithms or inventions that already stand on their own. ³Altavista—http://www.altavista.com/

In the flowchart of FIG. 2, step (d), the most basic method of extracting keywords from the search results is to take keywords directly associated with the documents, as described before. However, the present invention could also employ other methods for extracting keywords from documents. There exist algorithms that can cull the most important words from a given document, and these algorithms could be plugged into the present invention's architecture. Other algorithms could rely on a saved database of previous user query keywords, associated with the documents they most often chose for those keywords. (For the purpose of sifting later on in phase three, in all cases where keywords are extracted from the document using such algorithms, the present invention should remember the keywords that belong to each document in addition to storing them all in a master keyword list.) In running through the list of search results to gather keywords, the present invention could also modify the list of search results itself. For example, if the implementation is programmed to use only keywords associated with the documents, it could throw out results which do not have any keywords associated with them. To sum up, any means of obtaining keywords from the documents can potentially function inside of the present invention. The examples given here are illustrative only, and should be understood not to limit the scope of this invention, nor broaden it to encompass algorithms or inventions that already stand on their own.

Also in the flowchart of FIG. 2, step (d), during the extraction of keywords, the present invention could gather statistical information about the keywords and documents, for use in the sifting operations or the sifting algorithm later. For example, the invention could count the number of documents with which each keyword is associated. It could count the number of documents in which two or more keywords appear together. It could gather information on which keywords appeared to be associated most strongly with their documents (by means of repetition within the document, or location of occurrence within the document, for example). In short, any statistics or other information that could be useful to the sifting in later stages may be gathered at this point by the present invention. The examples given here are illustrative only, and should be understood not to limit the scope of this invention, nor broaden it to encompass algorithms or inventions that already stand on their own.

In FIG. 2, (e), the present invention can optionally employ algorithms to improve the quality of the keywords. In many cases, a word that represents a single idea can have many forms (plural vs. singular; adjective and verbal forms; etc.). Without any optimization of the list of keywords, these variant forms can clutter the list and make it harder for the user to identify common themes in the keyword list. An example of such an algorithm could be grammatical analysis of words to reduce various forms into one keyword. Another algorithm could combine close synonyms when their meanings were found unambiguous, according to some database or computerized thesaurus. Statistical analysis could be performed on the keyword list, clustering related keywords, bringing common themes to the top, or weeding out keywords unlikely to be chosen, for example. These algorithms can be as simple or as complex as desired. The examples given here are illustrative only, and should be understood not to limit the scope of this invention, nor broaden it to encompass algorithms or inventions that already stand on their own.

In the description of FIG. 2, steps (g) and (h), sifting operations such as “include” or “exclude” were mentioned as examples. Other sifting operations could be devised that may prove useful as well. For example, sifting operations which use fuzzy logic, or word counts, or relevance algorithms, or require that the keyword be a central theme in the document, etc. to include, exclude or rank documents could all be used within the framework of the present invention. All that is required is that the operation relate the keyword to the document in some way useful to the sifting algorithm of FIG. 2, (h). The examples given here are illustrative only, and should be understood not to limit the scope of this invention, nor broaden it to encompass operations, algorithms or inventions that already stand on their own.

FIG. 2, step (h) represents the sifting of the search results using keywords and sifting operations. The sifting may also optionally reorder the results according to some calculated rank given each one, as described before. The ranking algorithm may be cumulative; that is, it may combine the rankings of several different keywords and sifting operations for a single document to produce that document's final ranking in the list. The algorithm may be defined primarily by the sifting operations; it may have some cumulative functions such as counting the number of matched keywords; or it may even involve a much more complicated process within the sifting algorithm such as relating documents to each other, grouping them by topic and/or keyword density, etc. The examples given here are illustrative only, and should be understood not to limit the scope of this invention, nor broaden it to encompass operations, algorithms or inventions that already stand on their own.

It should now be clear to any skilled programmer or software engineer how to put together a system implementing the architecture of the present invention. Many possible different ways of implementing certain parts of the present invention have been set forth, and to repeat, these should not be construed to limit the scope of the invention nor broaden it to encompass pre-existing or independently developed mechanisms, algorithms or inventions. Moreover, the exclusion of a particular algorithm from the list of examples for each of those parts should not be construed as limiting the present invention from using such algorithm. The appended claims which define the scope of this invention are made independent of any and all such complementary algorithms, mechanisms or inventions.

I claim:

1. A method of sifting the results of a search query using keywords from said search results, said method comprising the steps of:
(a) extracting keywords from each search query result;
(b) compiling said keywords from said search results into a single list of keywords;
(c) presenting said list of keywords and said search results to the user;
(d) providing a method for the user to select keywords from said list and apply sifting operations to those keywords;
(e) creating a derived list of search results from the initial list by applying said user-selected sifting operations on said user-selected keywords to each result in the list of initial search results, with the end result being the exclusion of certain results from said derived list, based on said keywords, said sifting operations, and/or said search results themselves.

2. The method according to claim 1, step (e), wherein in addition to excluding certain search results from the derived list, the method also optionally ranks and/or reorders the remaining results within the derived list, based on the keywords, the sifting operations, and/or the search results themselves.

3. The method according to claim 1, steps (d) and (e), wherein the sifting operations include but are not limited to the following:
(a) “including” results from the initial list that are associated with a given keyword;
(b) “requiring” that all results in the derived list be associated with a given keyword;
(c) “excluding” results from the initial list that are associated with a given keyword; or
(d) any other operation which may include or exclude a result in the derived list based on a given keyword and its association with that result, or which may rank the result within said derived list.

4. The method according to claim 1, further comprising the step of providing the user with a method to select a particular search result and display it.

5. The method according to claim 1, further comprising the step of combining the user-selected keywords and sifting operations with the original search query to formulate a new, more targeted search query.

6. The method according to claim 1, further comprising the steps of:
(a) inputting a search query from the user;
(b) submitting said search query to a search engine, whether internal or external to the present invention; and
(c) retrieving the search results directly from said search engine.

7. The method according to claim 6, further comprising the steps of:
(a) reformulating said search query individually for one or more search engines,
(b) submitting said reformulated search query to each of said one or more said search engines,
(c) combining the search results from the said one or more search engines into one single list of search results.

8. The method according to claim 1, step (a), wherein the extraction of keywords from a document in the list of said search results comprises one or more of the following steps:
(a) reading a list of keywords previously associated with the document;
(b) using a separate open or proprietary algorithm (the inner workings of which are not claimed here) to extract the most likely keywords from the document; or
(c) using any other suitable method or mechanism (the inner workings of which are not claimed here) that associates documents with appropriate keywords.

9. The method according to claim 1, step (b), wherein the compilation process comprises one or more of the following steps:
(a) combining keywords that are different forms of the same word by means of grammatical analysis algorithms (the inner workings of which are not claimed here);
(b) combining keywords that are synonyms using a database or thesaurus, in cases where such combination is mostly unambiguous (the specific mechanism for doing which is not claimed here);
(c) grouping or clustering keywords that are similar or have similar meanings according to some algorithm or method (the inner workings of which are not claimed here);
(d) excluding keywords that are deemed to be of little use according to some algorithm or method (the inner workings of which are not claimed here); or
(e) any other algorithm which may optimize the final list of keywords (the inner workings of which are not claimed here).

10. The method according to claim 1, step (b), wherein during the compilation process any of the following pieces of information are gathered:
(a) statistics on each keyword, including but not limited to the number of search results with which said keyword is associated;
(b) statistics on sets of keywords, such as the number of documents in which two or more keywords appear together; or
(c) any other information or statistics that can be derived from the keywords and the search results themselves by any algorithm (the inner workings of which are not claimed here) and which may be of use to the user or other algorithms within this invention.
